(19) United States
(12) Patent Application Publication
(10) Pub. No.: US 2008/0004169 A1
(43) Pub. Date: Jan. 3, 2008

(54) Ultra low expansion glass and methods for making

(76) Inventor: Adam James Ellison, Painted Post, NY (US)

Correspondence Address: CORNING INCORPORATED, SP-TI-3-1, CORNING, NY, 14831, US

(21) Appl. No.: 11/821,800

(22) Filed: Jun. 26, 2007

Related U.S. Application Data
(60) Provisional application No. 60/817,332, filed on Jun. 28, 2006.

(51) Int. Cl. C03C 3/06; C03C 3/076

(52) U.S. Cl. 501/54; 501/55

(57) ABSTRACT

A low expansion silica-titania glass suitable for making extreme ultraviolet lithographic element, with the titania-containing silica glass having a titania content in the range of 5-10 wt. % and a including a further constituent of a viscosity reducing dopant having a content in the range of 0.001 to 1 wt %.

### BACKGROUND

1. Technological Field

This invention relates to extreme ultraviolet elements made from glasses including silica and titania. In particular, the invention relates to a low expansion glass doped with titania and a second viscosity-reducing dopant and elements made therefrom that exhibit reduced striae.

Furthermore, the invention relates to a method for making such glass and optical elements which are suitable for in extreme ultraviolet lithography applications.

2. Technical Background

Ultra low expansion glasses and soft x-ray or extreme ultraviolet (EUV) lithographic elements made from silica and titania traditionally have been made by flame hydrolysis of organometallic precursors of silica and titania to form boules of glass from which the EUV elements are extracted and produced. Ultra-low expansion silica-titania articles of glass made by the flame hydrolysis/boule method are used in the manufacture of elements used in mirrors for telescopes used in space exploration and extreme ultraviolet or soft x-ray-based lithography. These lithography elements are used with extreme ultraviolet or soft x-ray radiation to illuminate, project and reduce pattern images that are utilized to form integrated circuit patterns. The use of extreme ultraviolet or soft x-ray radiation is beneficial in that smaller integrated circuit features can be achieved, however, the manipulation and direction of radiation in this wavelength range is difficult. Accordingly, wavelengths in the extreme ultraviolet or soft x-ray range, such as in the 1 nm to 70 nm range, have not been widely used in commercial applications. One of the limitations in this area has been the inability to economically manufacture mirror elements that can withstand exposure to such radiation while maintaining a stable and high quality circuit pattern image. Thus, there is a need for stable high quality glass lithographic elements for use with extreme soft x-ray radiation.

One limitation of ultra low expansion titania-silica glass made in accordance with the method described above is that the glass contains some level of striae. Striae are compositional inhomogeneities which adversely affect optical transmission in lens and window elements made from the glass. Striae can be measured by a microprobe that measures compositional variations that correlate to coefficient of thermal expansion (CTE) variations of a few ppb/° C. In some cases, striae have been found to impact surface finish at an angstrom root mean rms level in reflective optic elements made from the glass. Extreme ultraviolet lithographic elements require finishes having a very low rms level.

It would be advantageous to provide improved methods and apparatus for manufacturing ultra low expansion glasses containing silica and titania. In particular, it would be desirable to provide extreme ultraviolet elements exhibiting reduced levels of striae and methods and apparatus that are capable of producing such reduced striae level glass elements. In addition, it would be desirable to provide improved methods and apparatus for measuring striae in ultra low expansion glass and extreme ultraviolet lithographic elements.

It is desirable to identify ways to minimize the initial formation of striae and/or to eliminate them after the boule is formed. Significant reductions in striae amplitude and increases in striae frequency have been obtained by ingenious combinations of burner conditions, spirograph patterns and laydown rates; however, the striae are still present, albeit in low and reduced levels. It is unlikely that any specification for striae that will suffice today will remain acceptable indefinitely, and it is expected that the semiconductor industry is likely to continue with development activity around striae reduction and management.

Alternatively, composition modification has been investigated as a means to diminish the amplitude of striae, namely by decreasing the viscosity of the glass at the laydown temperatures so as to facilitate interdiffusion of the components of the striae. Were this to occur, then in the time required for the laydown process itself, it might be possible to cause glass components to mix with one another sufficiently to overcome the deficiencies of the laydown process.

It would be advantageous to provide improved glasses, as well as methods for producing ultra low expansion glasses containing silica and titania. In particular, it would be desirable to provide extreme ultraviolet elements exhibiting reduced levels of striae and methods capable of producing such reduced striae level glass elements.

### SUMMARY

One aspect of the invention is directed at a low expansion silica-titania glass suitable for making extreme ultraviolet lithographic element. The titania-containing silica glass has a titania content in the range of 5-10 wt. % and a includes a further constituent of a viscosity reducing dopant having a content in the range of 0.001 to 1 wt %.

The viscosity reducing metal or nonmetal dopant can be introduced directly in the glass formation process via a liquid or gaseous feed into a modified burner assembly, or, in the case of alkalis, introduced via diffusion into the final glass. The viscosity-modifying component reduces the viscosity of the glass, accelerating interdiffusion of major glass constituents thus resulting in the glass having striae of a reduced amplitude.

In addition to the reduction on the amplitude of striae feature, other advantages include: (1) greater uniformity glass articles can obtained following post-glass formation grinding and polishing; (2) reduced sensitivity to exact part orientation with respect to any optical path the optical element may be used in; (3) post formation thermal processing, particularly heat treating, will produce a more relaxed glass; (4) the physical properties of the glass are; (5) the ultraviolet transmission is unaffected (or slightly improved) for wavelengths >300 nm; (6) the mechanical and chemical durability is unaffected by the low viscosity reducing dopant levels utilized.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention are intended to provide an overview or framework for understanding both the nature and character of the invention as it is claimed.

The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

FIG. 1 is a graph illustrating a standard prior art scattering vs. K₂O relationship;

FIG. 2 is a graph illustrating the electron microprobe diffusion profile of sodium into a fused silica material. The curve is a complimentary error function fit to the data.

### DETAILED DESCRIPTION OF THE PREFERRED EMBODIMENTS

The invention described herein is directed at a low expansion silica-titania glass suitable for making extreme ultraviolet lithographic element. The titania-containing silica glass has a titania content in the range of 5-10 wt. % and a includes a further constituent of a viscosity reducing dopant having a content in the range of 0.001 to 1 wt %.

The viscosity reducing dopant for use in this low expansion silica-titania glass is a metal or nonmetal dopant selected from the group consisting of alkalis, alkaline earths, aluminum, fluorine, chlorine, or other metals (La, Y, Zr, Zn, Sn, Sb and P) that do not produce strong coloration.

In a further embodiment, the low expansion glass viscosity reducing dopant is an alkali metal selected from the group consisting of K, Na, Li, Cs, and Rb.

It should be noted that certain combinations of the aforementioned glass viscosity reducing dopants may work better than the use of individual glass viscosity reducing dopants, due to an additive effect; as long as the total amount of the combination is less than 1 wt. %. However, the use of more than two glass viscosity reducing dopants is not preferred due the increase in manufacturing process complexity

In a still further embodiment the low expansion glass viscosity reducing dopant is included in an amount less than 2000 ppm, preferably less than 500 ppm, though at a level sufficient to reduce the viscosity of glass so as to result in a glass article having reduced amplitude stria.

A number of representative compositions for use in the present invention are detailed in Table I; the constituent amount listed therein are listed in weight percent.

TABLE I

| | 1 | 2 | 3 | 4 | 5 | 6 | 7 | 8 |
|---|---|---|---|---|---|---|---|---|
| SiO₂ | 93 | 93 | 93 | 92.9 | 93.1 | 92.9 | 92.7 | 92.5 |
| TiO₂ | 6.9 | 6.9 | 6.9 | 6.9 | 6.7 | 6.9 | 7 | 7.2 |
| Li2O | 0.1 | | | | | | | |
| Na₂O | | 0.1 | | | | 0.1 | | 0.11 |
| K₂O | | | 0.1 | | | | | |
| Al2O3 | | | | 0.2 | | | 0.2 | 0.28 |
| F | | | | | 0.1 | 0.1 | 0.1 | |

The use of the viscosity reducing dopants functions to reduce the viscosity of the glass at high temperature, thereby reducing the amplitude of striae produced by direct-to-glass laydown processes, such as those used to prepare Corning glasses such as Code 7980 HPFS™ fused silica glass or ULE™ Ti-doped fused silica glass. In applications for which deep UV transmission is of secondary importance, e.g., reflectance optics and near UV photolithography, the use of viscosity reducing dopants can be used to minimize the impact of striae on the physical and mechanical properties of the final glass.

The process for producing pure silica and titania-silica uses an array of burners to oxidatively combust one or more organometallic precursor (e.g., octamethylcyclotetrasilane and titanium isopropoxide), deposit the small oxide balls produced onto a surface, and heat the surface high enough that the oxide balls meld together to produce dense glass. As the burners traverse over the surface, and as the surface moves closer to the burner with time, heterogeneities in density and composition are produced which result in index fluctuations or striae that are roughly parallel to the deposition surface. In fused silica, the striae arise largely from variations in water content, whereas in ULE Ti-doped fused silica glass they arise from local variations in the relative concentrations of the TiO₂ and SiO₂. The striae are problematic for a number of reasons. First, if they produce changes in the mechanical or chemical durability of the material, then they can interfere with grinding and polishing a smooth surface in the glass. This is particularly troubling for EUV applications involving ULE Ti-doped fused silica. Second, where the compositional variations lead to differences in response to radiation, e.g., H₂ or H₂O content, the striae can contribute to a higher level of damage under fluence than would be estimated from the lump concentration of the component in question. Third, if the striae are not exactly perpendicular to the line of sight, they can distort an image projected through the glass, producing fringes and decreasing resolution.

Prior art has demonstrated that using low levels of alkalis to reduce the fictive temperature of silica was a highly-effective means of reducing Rayleigh scattering and hence improving fiber transmission. Modeling results indicated that less than 1 wt % of an alkali oxide such as sodium or potassium would be sufficient to reduce the fictive temperature of silica so as to produce an ultra low loss telecommunications fiber. Prior art teaches that much lower levels of alkalis and alkaline earths are sufficient to produce a dramatic decrease in fictive temperature and avoid other types of losses that are associated with multicomponent glasses.

Additionally it is known in the art that less than 1 wt % of alkalis, alkaline earths, lead, aluminum, and other cations that do not produce strong color in glass can be used to lower the melting temperature of silica by several hundred degrees while preserving the essential transparency and excellent physical properties of pure silica.

A number of methods/process exist for producing alkali-doped silica and alkali+fluorine doped silica (including CVD, sol-gel and direct melting from raw materials), most of which generate silica with sufficiently low levels of absorbing impurities to be useful in telecommunications applications as a core or clad glass. In practice, these methods have proved challenging to implement because the viscosity of the doped glass has been reduced so much relative either to pure silica or fluorine-doped silica that the doped glass flows around and through the undoped glass at consolidation and fiber draw temperatures, thus interfering with geometry control.

The reduced fictive temperatures and the low melting temperatures disclosed above are a manifestation in the overall dramatic decrease in the viscosity of pure silica produced by low levels of nearly any electropositive cation. Examples of suitable cations include the alkalis, alkaline earths, yttrium, lanthamides (especially those with no optical absorptions), lead and aluminum. In each case, low doping levels reduce the viscosity at all temperatures, whether those associated with primary melting, with the glass transition or anything in between. It is well known that for any particular temperature T, the viscosity □(T) and the diffusivity D(T) of a glass component are linked via the Stokes-Einstein relation,

D(T)∝k_{B}T/a□(T),
where k_{B} is the Boltzmann constant and a is the effective radius of the glass component involved in the diffusive process (10).

While not intending to be limited by theory the inventor, based in part on the principles set forth above, surmised that if a component reduces the viscosity of a glass, then the rate of diffusion of any given glass component must increase proportionately. Therefore, those components that reduce the viscosity of Ti-doped silica may potentially also increase the rate of diffusion of the silicate and titanate species within the glass. It follows that since these species are part of current described structures, density heterogeneities or compositional heterogeneities (such as stria), would likely deteriorate more rapidly in the presence of the viscosity-reducing component than were it absent.

Evidence that this process will work is seen in high-temperature heat treatments of ULE Ti-doped fused silica glass. Exposing bare ULE to a burner at high temperature for an extended period of time, resulted in little change in the amplitude of striae. However, when by placing ULE in a zircon container and holding at high temperature for an extended period of time, the amplitude of striae are reduced nearly to the point of elimination. Furthermore, it has been shown that a method for suppressing alkali migration from zircon refractory into fused silica in the direct-to-glass hydrolysis process. This process occurs even when the zircon refractory is subjected to an aggressive chlorine leach, because the alkali that remains is thermally—rather than chemically-mobilized in the laydown process. Deliberate updoping of the refractory with sodium (e.g., water glass) might be all that is required to obtain the desired viscosity modification.

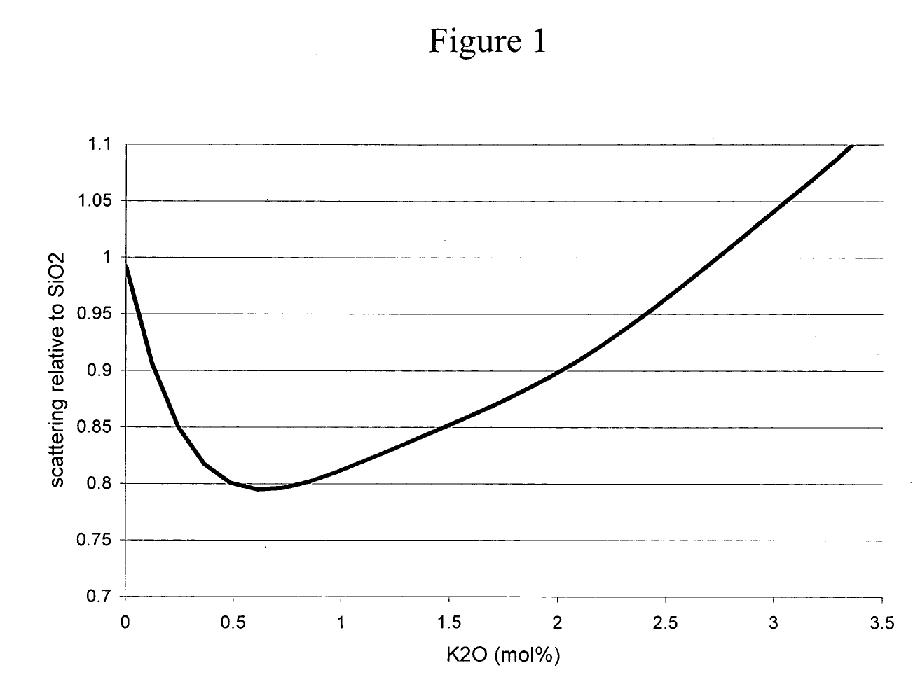

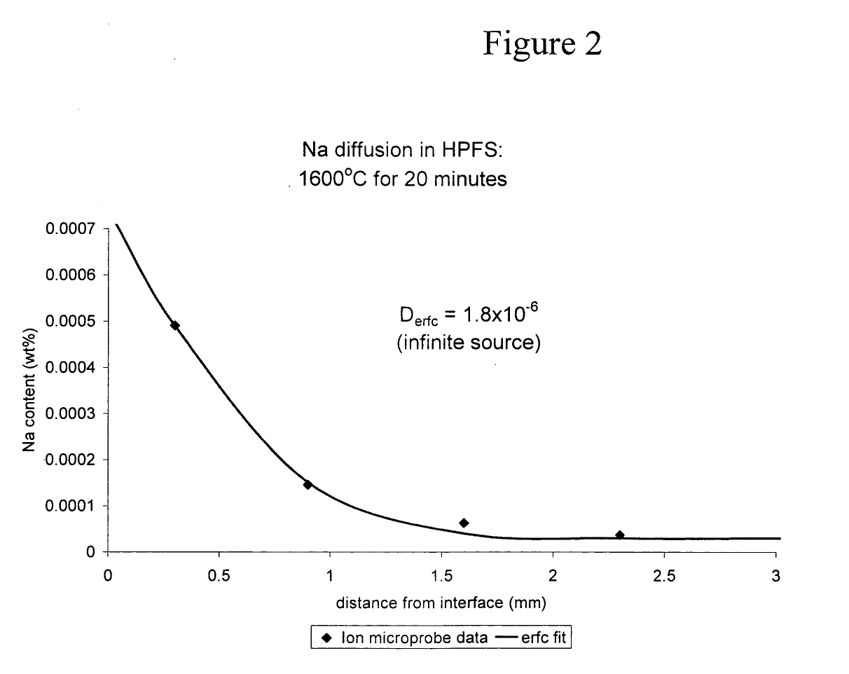

The inventors have theorized that alkalis are particularly well suited for this application because of their very large impact on viscosity at low concentrations and very high diffusivity at lay down temperatures; these two features are illustrated in FIGS. 1 and 2 respectively. In particular, FIG. 2 demonstrates the electron microprobe diffusion profile of sodium into a fused silica material; specifically Corning HPFS fused silica material after 20 minutes exposure at 1600° C. The former leads to rapid homogenization of compositional heterogeneities, as indicated above, whereas the latter means that even an oscillatory, discontinuous or post-laydown process for incorporating alkalis may still produce a uniform impact on viscosity and other physical and optical properties.

Lastly, the inventors have also determined that aforementioned methods for producing the Ti-doped glasses observed that these methods typically result in relatively high OH— levels, typically greater than 100 ppm. This amount OH has been observed to produce a synergistic effect in conjunction with the other viscosity reducing dopants to produce a enhanced decreased/reduced viscosity effect.

### EXAMPLES

The present invention is further described by the following non-limiting examples.

### Example 1

The following example is illustrative of methods that can be used to make a representative composition as described above. Liquid organic precursors of titanium and silicon are combined in a feeder tube to a burner that combusts them together in the presence of oxygen and methane or hydrogen gas to create a fine soot. Suitable precursors are any alkoxides, silanes, and mixed silanes/alkoxides, of which particularly useful examples are octamethylcyclotetrasilane for silicon, and tetraisopropoxy titane (titanium isopropoxide) for titanium. The reactants are mixed in a ratio such that the TiO₂ content of the final soot is within the desired range of 5-12 wt %, more preferably 6-8 wt %. The fine soot is collected using readily available technology for accumulating fine particulates, such as a cyclone collector. The soot is suspended in a concentrated solution of ammonium hydroxide to which is added one or more of the hydroxides LiOH, NaOH, KOH, RbOH, or CsOH. The soot loading level is preferably at least 50% by weight relative to ammonium hydroxide, and soot loadings up to 80% by weight can be achieved with vigorous stirring. In this example, approximately 1000 g of soot so generated is added to 1000 g of 30% ammonium hydroxide.

The level of alkali hydroxide is selected so as to provide the desired doping level in the final material, and thus is added in proportion to the amount of soot in the suspension. A typical final level will be 1000-3000 ppm by weight. For this example, 1 gram of lithium hydroxide is added to the ammonium hydroxide mixture before adding the soot.

The mixture of soot, ammonium hydroxide and alkali hydroxide is stirred and the temperature is monitored. Approximately 30 minutes after the temperature begins to increase, a gelling agent is added to drop the pH and compel the soot to condense from solution. Suitable gelling agents include, but are not limited to, ethylene glycol acetate, ethylene glycol diacetate, formamide, diacetin or triacetin. Hydrolyzable organometallic compounds can also be added, such as silicon tetraethylorthosilicate (TEOS), titanium isopropoxide, aluminum isopropoxide, boric acid, etc., though adjustments may be required to initial TiO₂ levels to ensure the appropriate CTE. In this example, 100 g of formamide is added to the soot suspension. The suspension gradually becomes viscous with these addition until an essentially gel-like material is obtained.

The gel is transferred to an oven to dry at 150° C. to make a dense cake. The dense cake can be melted directly to final form at 1650-1750° C., depending upon the level of alkali loading and the final TiO₂ content.

### Example 2

The following example illustrates a method for diffusing alkalis into a dense TiO₂—SiO₂ glass to make a new material with lower viscosity and better compositional uniformity. A suitable alkali source is prepared in advance. Suitable sources include refractory brick stable to high temperatures that includes an alkali-bearing grog or binder, or an alkali-bearing TiO₂—SiO₂ glass prepared by Example 1 or other suitable methods. An alkali-free glass is prepared via conventional CVD methods and a plate is cut with at least dimension suitable for diffusion, preferably about 1 cm thick or thinner. The plate of alkali-free glass is brought into intimate contact with the alkali source along the surfaces perpendicular to the desired diffusion direction, preferably with the alkali source on both sides of the alkali-free glass plate in a “sandwich” configuration. The sandwiched plate and the alkali sources are then heated to high temperature for an extended period of time. A typical temperature ranges between 1600-1700° C., and the hold duration is preferably on the order of 6-8 days, though lower duration holds will suffice if a profile in alkali concentration is acceptable. At the end of this time, the sandwiched configuration comprising the alkali source and glass plate is transferred to an anneler at 1000° C., held for 24 hours, and cooled at 1° C./min to room temperature.

### Example 3

A soot precursor of TiO₂ and Al₂O₃ is prepared and 1000 g of it is suspended in 1000 g of 30% ammonium hydroxide via a procedure akin to the first example. Separately, a water soluble salt of aluminum is dissolved in water. Suitable salts include halides and nitrates such as AlCl₃.6H₂O and Al(NO₃)₃.9H₂O. The salt loading is preferably about 20-50% by weight with respect to water, though lower loading levels will suffice as well. In this example, approximately 24 g of AlCl₃.6H₂O is dissolved in 50 g of water to make the salt solution. Approximately 30 minutes after the temperature begins to rise, the aluminum salt solution is slowly added to the soot suspension, stirring very vigorously. If clumping occurs initially, a small amount of fresh ammonium hydroxide may be added to re-establish flow. Once the salt solution is dispersed, the soot suspension will begin to thicken, and will gel completely roughly an hour or less. The gel is dried and fired into dense ware via a procedure like that described in Example 1.

### Example 4

Organometallic precursors for titanium and silicon are directed through a burner along with a solution of an aqueous or alcohol solution containing a soluble aluminum salt, such as the chlorides and nitrates described in Example 3. The salts decompose in the combustion atmosphere, creating a uniform soot comprising titanium, silicon, aluminum and oxygen. The soot can be collected on a bait rod as in an outside vapor deposition approach (OVD) and consolidated under helium. It can be collected on a bait plate or substrate and converted to glass via consolidation or directly to glass if the substrate temperature is kept high enough. Once fused, the glass is annealed at approximately 1000° C. and cooled to room temperature.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A low expansion silica-titania glass suitable for making extreme ultraviolet lithographic elements, said glass comprising:
a titania-containing silica glass having a titania content in the range of 5-12 wt. % and a including a viscosity reducing dopant having a content in the range of 0.001 to 1 wt %.

2. The low expansion glass according to claim 1 wherein the viscosity reducing dopant is a metal or nonmetal dopant is selected from the group consisting of alkalis, alkaline earths, aluminum, fluorine, chlorine, or other metals that do not produce strong coloration.

3. The low expansion glass according to claim 1 wherein the viscosity reducing dopant is an alkali metal selected from the group consisting of K, Na, Li, Cs, and Rb, and combinations thereof.

4. The low expansion glass according to claim 1 wherein the viscosity reducing dopant is present in amounts less than about 2000 ppm.

5. The low expansion glass according to claim 1, wherein the glass has a coefficient of thermal expansion in the range of 0±3 ppb/° C. in the temperature range 5-35° C.

6. The low expansion glass according to claim 1, wherein the titania content is in the range of 7.25 to 8.25 wt. %.

7. The low expansion glass according to claim 1, wherein the OH concentration exceeds 100 ppm.

8. An optical element suitable for extreme ultraviolet lithography, a titania-containing silica glass having a titania content in the range of 5-10 wt. %, a viscosity reducing dopant having a content in the range of 0.001 to 1 wt %, a polished and shaped surface, and a coefficient of thermal expansion of 0±3 ppb/° C. in the temperature range 5-35° C.

9. The optical element according to claim 8 wherein the viscosity reducing dopant is a metal or nonmetal dopant is selected from the group consisting of alkalis, alkaline earths, aluminum, fluorine, chlorine, or other metals that do not produce strong coloration.

10. The optical element according to claim 8 wherein the viscosity reducing dopant is an alkali metal selected from the group consisting of K, Na, Li, Cs, and Rb, and combinations thereof.

11. The optical element according to claim 8 wherein the viscosity reducing dopant is present in amounts less than about 2000 ppm.

12. The optical element according to claim 8, wherein the glass has a coefficient of thermal expansion in the range of 0±3 ppb/° C. in the temperature range 5-35° C.

13. The optical element according to claim 8, wherein the titania content is in the range of 7.25 to 8.25 wt. %.

14. The optical element according to claim 8 wherein the OH concentration exceeds 100 ppm.
